(19) United States
(12) Patent Application Publication
(10) Pub. No.: US 2008/0310152 A1
(43) Pub. Date: Dec. 18, 2008

(54) Led Lighting

(75) Inventors: Stefan Marcus Verbrugh, Eindhoven (NL); Nicola Bettina Pfeffer, Eindhoven (NL); Simon Jacobus Maria Kuppens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,909

(22) PCT Filed: Jun. 23, 2005
(86) PCT No.: PCT/IB05/52076

§ 371 Date: Dec. 19, 2006

(30) Foreign Application Priority Data
Jun. 29, 2004 (EP) 04103044.6

(51) Int. Cl. F21V 9/00; F21V 21/00

(52) U.S. Cl. 362/231; 362/249

(57) ABSTRACT

The present invention generally relates to a lighting system comprising LED modules (10, 20), arranged adjacent to each other, preferably in a matrix configuration. By introducing light apertures (101) between two or several adjacent modules, each comprising a mixing chamber (11, 21), light is transmitted sideways between the mixing chambers of the adjacent modules, whereby the perceived lighting from the associated module windows is equalized. Hence, the invention facilitates an homogenization of perceived illumination without the need for an electronic control system.

### FIELD OF THE INVENTION

The present invention generally relates to a lighting system comprising LED modules, and more specifically to a system and a method which improves the lighting characteristics of a LED module system, as well as to a LED module for use in such a system.

### BACKGROUND OF THE INVENTION

It is well known to use modules comprising light emitting diodes (LEDs) when arranging lighting systems for general lighting applications. When designing these LED systems and LED modules care is taken to achieve a system, which facilitates the desired intensity, uniformity and color respectively color temperature, and which preferably requires a minimum amount of design work. Generally, a system wherein the lighting is as homogenous as possible is most preferred.

In one type of conventional LED modules a light mixing chamber is used for diffusing the light from one or several LEDs, in order to achieve a more homogenous light from the mixing chamber in which the LEDs are comprised. In particular, if light from several LEDs, having different colors, is emitted in the mixing chamber, the chamber can also act as a color mixing chamber. In this case the chamber diffuses the light from the different colored LEDs, such that the light leaving the chamber is perceived as having a homogenous color. This color can for example be white, if the LED system and the mixing chamber is arranged accordingly.

A problem related to LED systems comprising several adjacent mixing chambers, is that the light emitted from different chambers is not perceived as having the same intensity or color. This can for example be due to that the light intensity and color or wavelength varies between different or individual LEDs, i.e. if the same current is applied to two individual LEDs the intensity or color temperature might still differ between the two LEDs. Moreover, individual LEDs age differently, i.e. the parameters for one particular LED changes differently over time, compared to the parameters for another LED. Therefore, care is taken to control the intensity and color of the LEDs, by controlling the current applied to said LEDs.

WO2004/002198 discloses an arrangement for controlling and maintaining the light characteristics from a LED module. According to this document light intensity and color of a LED module is measured and kept constant with the use of optical sensors, supporting electronics and a control system, where the optical sensors are mounted between the LEDs.

One drawback associated with the described way of controlling the light distribution, is that it requires a design of a control system. Another, that the sensors and control system might restrict the design of the lighting system. A third, that the sensors adds volume to the design and might shadow the light distribution from the LEDs. A fourth, that it is unreliable, as it requires that all the sensors are working properly. For example if one of the sensors is damaged or soiled, the system will not regulate the associated LED(s) correctly.

### SUMMARY OF THE INVENTION

It is an object of the present invention to eliminate, or at least alleviate, the described problems associated with LED lighting systems.

The invention is based on an insight that by introducing light apertures between two or several adjacent modules, each comprising a mixing chamber, such that light is transmitted sideways to and from the mixing chambers of the modules, the perceived lighting from said modules is equalized. In other words, since not only the light from one mixing chamber is diffused or mixed in said chamber, but also the light from adjacent mixing chambers, the differences between light emitted from different modules, with regard to for example color temperature and light intensity, are reduced. Moreover, when looking straight at such a system of modules, or the reflection of light emitted from such a module system, it is perceived as more uniform and homogenous compared to a system lacking the apertures mentioned above. This is advantageous as many customers favor homogenous lighting systems.

The object of the present invention is achieved by a system, a module, a method and use in accordance with the appended claims 1, 10, 13 and 15. Preferred embodiments are defined in the dependent claims.

According to a first aspect, the present invention provides a general lighting system, which comprises a first LED module and at least a second LED module arranged adjacent to each other. Further, each of these modules have a light mixing chamber, and at least one LED for emitting light, in said chamber and outwards thereof through a module lighting window. Further said lighting system comprises at least one light aperture, which is arranged between adjacent modules for enabling light from one of said modules to pass into the light mixing chamber of an adjacent module, and vice versa. The mixing chamber of a module is arranged such that both light emitted by LEDs in said module, and light transmitted into the module chamber through said aperture from an adjacent module, is diffused and mixed in said chamber in such a way that the perceived lighting from the associated module light windows is equalized.

One purpose of the light mixing chamber is to as emit as much light as possible, while realizing the light output uniformity required. The light mixing chamber can also be used for mixing the light from several LEDs, having different colors. According to the invention the chamber is further used for mixing light emitted in one module with light from an adjacent module. Moreover, it is to be understood that the module light emitting window does not comprise said aperture between adjacent modules. Rather, in most cases, said aperture and said module light window are directed in orthogonal directions.

According to a second aspect, the present invention provides a lighting module, which is to be used in a general lighting system, as described in relation to said first aspect. Said module is provided with at least one aperture as described in relation to said first aspect, such that if a first and a second such module are arranged adjacent to each other, LED light can be transmitted from said first into the diffusing and mixing of said second module, and vice versa.

According to a third aspect, the present invention provides a method of improving lighting from adjacent LED modules in a general lighting system, wherein each of said modules comprises a light mixing chamber, by transmitting LED light from one of said modules into a light mixing chamber of an adjacent module, and vice versa, for equalizing the perceived lighting from the associated module lighting windows.

According to a fourth aspect, the present invention provides use of at least one light transparent aperture in framing structures of adjacent lighting modules of a general lighting system, for enabling light transfer between the mixing chambers of said modules, in order to equalize a perceived lighting from module lighting windows associated with said LED modules.

One advantage associated with the four aspects mentioned above is that a more homogenous light distribution is provided from said lighting system, without the use of any extra components. Therefore, a compact design of the lighting system can be maintained. Another advantage is that this more homogenous light distribution is provided without having to rearrange the LEDs. Therefore, the present invention is usually convenient to implement.

Below is listed a number of advantages related to different embodiments of the invention. Common for all of these are that the systems described provide an equalization of the perceived lighting from the associated module lighting windows.

In a lighting system, as defined in claim 2, said modules are arranged adjacent to each other in two dimensions, in such a way that they provide a matrix of adjacent modules. For example, a first line of adjacent modules is arranged adjacent to a second line of adjacent modules etc. In this way a matrix of light modules can be achieved, which matrix has a homogenous light distribution.

A lighting system, as defined in claim 3, wherein each LED module is a self-contained LED unit, has a framing structure comprising an aperture. As used herein the term “a self-contained unit” refers to a unit, comprising one or several modules, which can be used by itself, or preferably in combination with other units. These units advantageously facilitates the assembly of a large area LED system, by arranging units according to the invention adjacent to each other. Further, a large area LED systems having different geometrical configurations can be achieved, simply by arranging the modules differently.

A lighting system, as defined in claim 4, wherein said mixing chamber is reflective, having diffuse reflective and/or specularly reflecting walls, is advantageous as a reflective chamber facilitates an efficient diffusing and mixing of the light in the chamber. Such a diffusion is often needed in order to achieve a homogenous lighting, with high efficiency.

A lighting system, as defined in claim 5, wherein said modules substantially have the shape of rectangular parallelepipeds, triangles or hexagons advantageously facilitates the arrangement of several such modules in a matrix configuration, with a homogeneous lighting.

A lighting system, as defined in claim 6, wherein an aperture consists of light transparent plastic or glass, advantageously provides a more rigid construction of the lighting module.

In a lighting system, as defined in claim 7, each module comprises a group of LEDs. This is advantageous, as the lighting from each light mixing chamber will be an average of the light form each individual LED in said group, and thereby the lighting from said modules will be perceived as being more homogenous.

In another embodiment, as defined in claim 8, said group of LEDs is centered to substantially the middle of said module, with respect to said module lighting window. This is advantageous as less light is restricted by an edge framing said window, and hence more direct light from said LEDs is emitted through said window.

A lighting system, as defined in claim 9, has the advantage to facilitate almost any desired color, if the LEDs and the mixing chamber is arranged accordingly. By using a correct mix of e.g. red and yellow LEDs any shade of orange can be achieved. White can be achieved by mixing the light from e.g. a red, a green and a blue LED or e.g. a red, a blue, a yellow and a green LED. In most cases, by arranging several diodes in the same chamber a more homogenous light is achieved compared to arranging only one diode in each chamber.

A lighting system, wherein the aperture has a substantially rectangular shape provides an aperture which is easy to design and manufacture.

Some advantages, which are obtained by embodiments according to the invention, have been described above. Similar advantages can also be achieved by corresponding embodiments of said lighting system, said module and said method, and said use, as defined in the dependent claims related to the lighting module, the method and the use, respectively.

These and other aspects of the invention will be apparent from, and elucidated with reference to, the embodiments described hereinafter.

### BRIEF DESCRIPTION OF THE DRAWINGS

FIGS. 1A and 1B schematically shows a module according to the present invention.

FIG. 2 schematically shows a lighting system according to a first embodiment of the present invention.

FIG. 3 schematically shows another embodiment of the present invention.

FIG. 4 schematically shows a third embodiment of the present invention, wherein a set of modules is arranged in a matrix configuration.

### DESCRIPTION OF PREFERRED EMBODIMENTS

A description will be given of preferred embodiments according to the present invention, wherein like reference characters designate like or corresponding parts throughout the figures. All embodiments suitably comprises conventional electronic circuitry for operating the LEDs, which is known in the art and therefore is not described in more detail.

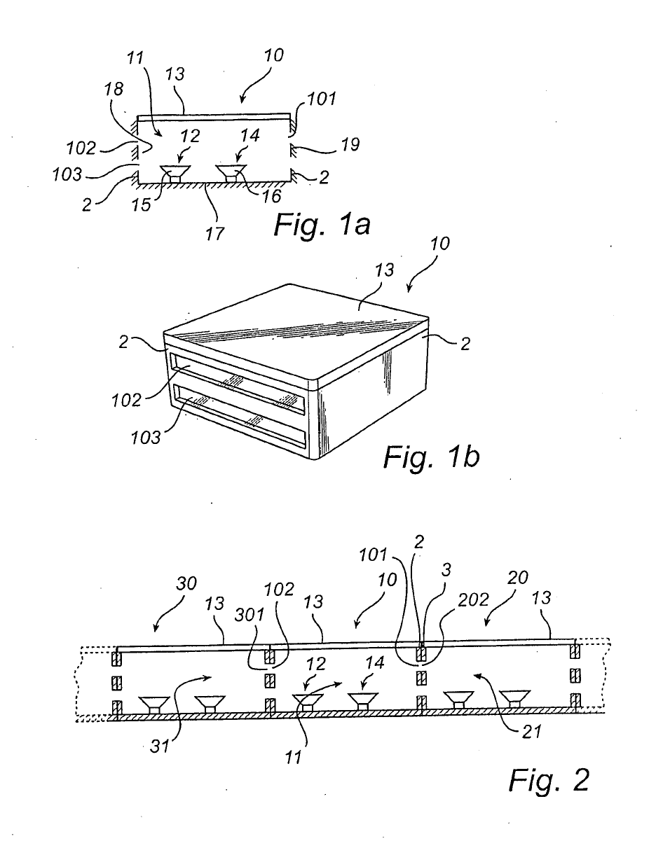

FIG. 1A shows a schematic cross-section of a LED module 10 according to the invention. The module comprises a light mixing chamber 11, wherein two LEDs 12,14, each surrounded by a reflector 15,16 and lenses, are arranged. In this embodiment side emitting LEDs are used. They have the advantage, by their side emitting radiation pattern, to facilitate the mixing of the LEDs with relatively low number of reflections at the walls. Hence, they can contribute to a high efficiency. The chamber wall is defined by a module framing wall structure 2 and a bottom, comprising a reflective, quadratic base plate 17 at which the LEDs are mounted. A framing wall structure 2 comprises four rectangular, reflective side walls 18,19, which are orthogonal to said base plate. Suitable reflective materials are e.g. Miro sheets from Alanod, which is a diffuse reflecting coating, Spectraflect reflectance coating from Labsphere and NBC coatings from Philips, containing highly reflective particles. Also an upper transmissive lighting module window 13, which is parallel to said base plate is provided. In other words, five of the chamber walls 17,18,19 are substantially reflective, so that light hitting them will be reflected back into the chamber 11, or out through the module lighting window 13. However, part of the light hitting the module lighting window 13 can also be reflected. As long as the light is reflected by a wall, it will keep hitting another wall, until it finds its way out through either the module light window 13 or an aperture 101 arranged in the module, unless a minor portion of the light that will be absorbed in the chamber 11.

In an arrangement without a mixing chamber 11 and wherein the module lighting window 13 is a normal transparent glass plate, someone looking at the module lighting window, would see two distinct light spots origin from the LEDs. By the introduction of a correctly designed chamber 11 a major part of the light, which would otherwise have been absorbed within the module, is now transmitted through the module lighting window 13. Moreover, the light emitted through this window will be more diffuse, as some of the light has bounced around inside the mixing chamber.

Generally, there are several different ways the LEDs 12,14 can be arranged inside a module 10. The LEDs can either all be of the same color, or one or several of them can be of different color(s) compared to the rest of the LEDS. White light can for example be achieved either by mixing the light from four different LEDs (e.g. a green, a yellow, a red and a blue) in the light mixing chamber, or by a blue LED coated with phosphor. Further, depending on the desired lighting design one can either arrange one or several LEDs in each module. Moreover, the LEDs can either be spread out or they can be centered to the middle of the module.

In accordance with the invention, there are light apertures 101 arranged in the side walls 18,19 of the module 10 in FIG. 1A. Each of these walls is provided with two spaced, elongated, rectangular light apertures 101,102, one above the other. The purpose of the apertures is to enable light to be transmitted out of the module and into a reflecting chamber of an adjacent module, and vice versa, in order to equalize the difference in perceived lighting from two modules. Therefore, the apertures 101,102 are arranged to mainly enable light to be transmitted in a direction which is substantially orthogonal to the main direction of the light transmitted through said module lighting window 13. In other words, under the presumption that the light emitted through said module lighting window is emitted upwards, the light transmitted through said apertures can be said to be emitted sideways. The size and shape of the apertures are dependent on the desired light distribution from the module. This is described further in relation to FIG. 2.

FIG. 1B is a three dimensional view of the same embodiment, as shown in FIG. 1A. The figure shows the quadratic, transmissive module lighting window 13 and structure 2, framing the module on four sides. At one of its sides, as well as the on the opposite side (not shown) the structure is provided with said two apertures 101,102.

In FIG. 2, schematically gives an overview of a module according to the present invention. A first module 10 is arranged between and adjacent to a second module 20 and a third module 30, such that they provide a line of modules. Each of the modules is internally arranged as described in relation to FIG. 1. According to the invention apertures 101,102,202,301 are arranged in the respective structures 2,3,4 defining the modules 10,20,30, such that light from e.g. the first module 10 is transmitted into the mixing chambers 21,31 of the surrounding modules 20,30 through the apertures 101,202 and 102,301 respectively, and vice versa. I.e. light from the surrounding modules 20,30 are also transmitted into the mixing chamber of said first module 10 through said apertures 101,202,102,301. The light apertures can be formed by holes in the wall structures or consist of glass or plastic, typically PMMA or Polycarbonate. The only requirement is that the aperture is transmissive to the relevant LED generated wavelengths. How the aperture is most preferably arranged depends on the application and design parameters, such as weight, cost, shock resistance and being waterproof. The aperture can be substantially large compared to the wall separating the modules, but the precise requirements are dependent on the desired light distribution and raytracing inside each module, as well as the homogeneity aimed for.

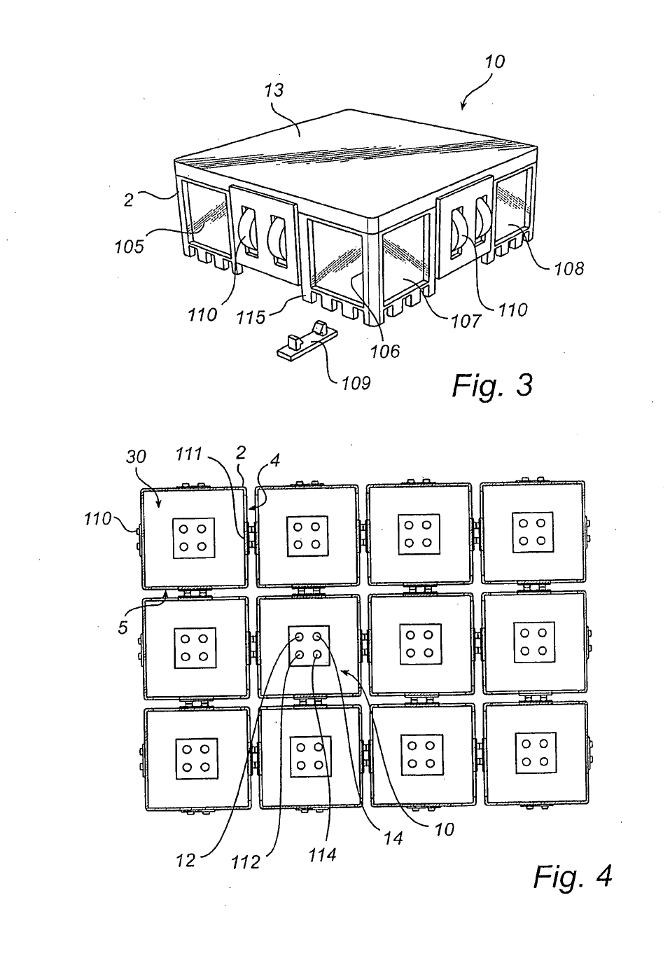

FIG. 3 schematically describes another embodiment of the invention, which has substantially all features in common with the embodiment described in relation to FIG. 1. Said Figure shows a lighting window 13 and a structure 2 defining said module, a substantially arranged as described above. Module apertures 105,106,107,108 are arranged in four sides of the framing structure 2, and are perpendicular to the module lighting window 13, for enabling a sideways distribution of the light in a matrix system. The apertures 105-108 are made substantially large compared to the side wall of the module. Further they are arranged on each side of locking means 110 known in the art, which are designed to engage with the corresponding locking means of an adjacent module, in order to stabilize a matrix configuration of modules. At the base of each module there are cooling fins 115, in order to facilitate cooling of the module. Further, in order to facilitate the arrangement of several modules into a matrix configuration, the modules have a substantial rectangular parallelepiped shape, i.e. three pairs of parallel rectangular sides. When tiling a matrix of such modules in two dimensions, each module is connected to a base plate socket 109, in a conventional manner. These modules are self-contained units, and in this embodiment the control system and electronics have been designed such that when mounting a unit, no other adjustments are needed, than to connect the unit to a socket, preferably provided with a connection for the electronics. A further advantage associated with self-contained modules is that the same modules easily can be arranged in different geometrical patterns, depending on the demands of the current lighting application.

In FIG. 4 twelve self-contained units, similar to those described in relation to FIG. 3, have been arranged adjacent to each other. Each unit is framed by a structure 2, wherein apertures are arranged. In one embodiment, depending on where in the matrix a module is arranged, a corresponding number of its walls is arranged with apertures, each arranged in accordance with the invention. For example, in a corner module 30 only two of the walls 4,5 are arranged with apertures, whereas in a center module 10 apertures are arranged in all four walls of the structure 2 framing said module 10. An advantage of making the framing surfaces of a matrix system reflective is that a more homogenous light distribution can be achieved towards the edges of a row or matrix. Generally, the same light distribution is preferred over the whole lighting surface. Another advantage is that more light is emitted through the module lighting window. Preferably, in a center module the surfaces 111 behind the locking means 110 are made reflective, so as to maximize the diffusion and mixing of the light in said the mixing chamber.

In a further embodiment the module side walls are interchangeable, i.e. they can be removed and replaced by a different side wall having the desired properties. For example, in an outer module of a matrix, a side wall, which is not adjacent to any other module wall, can be exchanged for a reflective wall. Moreover, if a module side wall is to be adjacent to another module, that side wall can be replaced by transparent plastic.

In yet another embodiment a lighting system or a matrix of self-contained units are mounted in a frame. The frame is arranged such that when the modules are mounted adjacent to each other in the frame, reflection surfaces of the frame will reflect light transmitted through the outer walls of said lighting system back into the modules again. This facilitates the use of the same type of modules, preferably center modules, in all positions of the matrix. Advantageously, by reflecting the light emitted through said outer walls back into the chambers, the amount of LED light transmitted through said module lighting window is increased.

The configurations of a number of different lighting modules are suggested above. However, other configurations are possible and can be considered without extending beyond the scope of the invention, as defined by the accompanying claims. It is understood that in this description the use of “comprising” does not exclude other elements or steps, and the use of “a” or “an” does not exclude a plurality.

1. A lighting system comprising:
a first LED module (10) and at least a second LED module (20) arranged adjacent to each other, each module having a light mixing chamber (11;21), and
at least one LED (12;22) for emitting light, in said light mixing chamber (11;21) and outwards thereof through a module lighting window (13;23); and
at least one light aperture (101) between said modules, for enabling light from one of said modules to pass into the light mixing chamber of an adjacent module, and vice versa, so as to equalize the perceived lighting from the associated module lighting windows.

2. A lighting system according to claim 1, wherein said modules are arranged in two dimensions, such that they form a matrix of adjacent modules.

3. A lighting system according to claim 1, wherein each LED module (10,20) is a self-contained unit which is framed by a structure (2) comprising said at least one light aperture (101).

4. A lighting system according to claim 1, wherein said mixing chamber (11,21) is reflective, so as to diffuse said LED light.

5. A lighting system for two dimensional tiling according to claim 1, wherein each of said modules substantially has the shape of a rectangular parallelepiped, a triangle or a hexagon.

6. A lighting system according to claim 1, wherein said aperture (101) comprises plastic or glass, which is transparent to said LED emitted light.

7. A lighting system according to claim 1, wherein said at least one LED is a group of LEDs.

8. A lighting system according to claim 7, wherein said group of LEDs are centered in said module, with respect to the lighting window of that module.

9. A lighting system according to claim 9, wherein said group of LEDs, comprises at least two LEDs having different colors.

10. A lighting module, for use in a lighting system as defined in claim 1, comprising:
a framing structure (2) defining a light mixing chamber (11);
at least one LED (12) for emitting light, in said light mixing chamber (11) and outwards thereof through a module lighting window (13); and
at least one light aperture (101), arranged in said framing structure (2), for enabling light from said at least one LED (12) to pass from said light mixing chamber into a mixing chamber of another such lighting module, and vice versa, when said modules are arranged adjacent to each other, for equalization of the perceived lighting from the associated module lighting windows (13,23).

11. A lighting module as defined in claim 10, wherein said module substantially has the shape of a rectangular parallelepiped.

12. A lighting module as defined in claim 10, wherein said light mixing chamber is reflective.

13. A method of improving lighting from adjacent LED modules (10,20) in a lighting system, wherein each module comprises a chamber for diffusing and mixing light from LEDs, comprising the step of transmitting LED light from one of said modules (10) into a light mixing chamber (21) of an adjacent module (20), and vice versa, for equalizing the perceived lighting from the associated module lighting windows (13,23).

14. A method according to claim 13, which further comprises transmitting said LED light through light apertures in a framing structure defining said modules.

15. Use of at least one light aperture (101) in framing structures of adjacent lighting modules of a general lighting system, for enabling light transmission between the mixing chambers of said modules, in order to equalize a perceived lighting from associated module lighting windows (13,23).
